(19) United States
(12) Patent Application Publication
(10) Pub. No.: US 2010/0008671 A1
(43) Pub. Date: Jan. 14, 2010

(54) High Density Wave Channel Optical Data Communications

(75) Inventor: Raymond Orson Pratt, Tehachapi, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: STANDARD SCIENTIFIC TECHNOLOGIES, INC., Los Angeles, CA (US)

(21) Appl. No.: 12/340,628

(22) Filed: Dec. 19, 2008

Related U.S. Application Data
(60) Provisional application No. 61/079,050, filed on Jul. 8, 2008.

(51) Int. Cl. H04J 14/02

(52) U.S. Cl. 398/83

(57) ABSTRACT

A high density data communications system and associated method comprises a multi-wavelength light source that provides a combined plurality of constituent lights having different wavelengths to a diffraction device that spatially separates the constituent lights to form a predetermined pattern of lights in order by their wavelengths, a light modulating processing array that individually modulates the separated lights in parallel according to data to form constituent light channels, a combiner that recombines the modulated separated light channels in parallel into a composite data communication light, a second diffraction device that spatially separates the modulated light channels into the predetermined pattern of wavelengths, and a demodulating processing array that extracts the data from the constituent modulated light channels.

### CROSS-REFERENCES TO RELATED APPLICATIONS

This application claims priority from U.S. Provisional Application No. 61/079,050, filed Jul. 8, 2008, and incorporated herein by reference in its entirety.

### BACKGROUND

The present invention relates to the optical communication of data and more particularly, to a system and associated method of providing a high density of individual optical wavelength channels for use in communicating data and signals.

The landscape of optical data communication systems, networks, and methods has changed significantly over the past years. Prior to the use of optical information communication, most long-haul telecommunication and other “wired” communication networks were generally handled via electrical domain transmission, such as provided through wire cables, which is bandwidth limited. Telecommunication service providers in particular have in more recent years commercially deployed optical transport networks having vastly higher information or data transmission capability compared to traditional electrical transport networks. Capacity demands have increased significantly with the advent of the Internet and continue to increase due to the rapid advancements in technology and the need for faster, more efficient, and accurate communications. Regardless of the reasons, the demand for data communication capacity increases dramatically every year.

Wave division multiplexing (“WDM”) and dense wave division multiplexing (“DWDM”) have contributed to increased efficiency in optical data communication. DWDM optical networks are deployed for transporting data in long-haul networks, metropolitan area networks, and other optical communication applications. In a DWDM system, a plurality of different light wavelengths, representing signal channels, are transported or propagated along fiber links or along one or more optical fibers comprising an optical span.

In a conventional WDM transmission system, an optical transmitter is composed of a number of individual semiconductor lasers having different wavelengths defined in a transmission specification, optical modulators for modulating optical outputs from the semiconductor lasers by means of transmitted signals, a multiplexer for multiplexing modulated signal lights to output a WDM signal light, and in most cases, an optical amplifier. An optical receiver connected to the optical transmitter via a transmission path optical fiber is composed of an optical amplifier for amplifying the transmitted WDM signal light, a demultiplexer for demultiplexing the WDM signal.

Each of the transmission units in a WDM system typically includes the semi-conductor laser light source with a certain wavelength and a modulator which modulates light from the light source by a transmission data string to generate an optical signal. Each of the wavelength multiplexing and separation devices includes a wavelength multiplex unit, a wavelength separation unit, an optical transmission amplification unit, and an optical receiving amplification unit.

The semiconductor lasers require a wavelength stabilizing circuit to maintain the wavelength accuracy defined in the transmission specification because the lasers are characterized by having their oscillation wavelengths shifted due to deviations in temperature, injected current, temporal deviations, and other effects. Since the wavelength stabilization must be carried out for each semiconductor laser, the area of the apparatus occupied by the wavelength stabilizing circuit and the complexity of circuitry increase consistently with the number of lasers added and the wavelength multiplexing operations required. This problem increases in severity as more channels are added in an attempt to increase the density of the data flow due to the increase in the number of lasers used and can become a significant problem for reliability and accuracy as well as substantially increasing costs.

As discussed above, in such a WDM transmission system increasing the number of wavelengths in order to increase the communication capacity of the system is met not only with stability problems of the semi-conductor lasers used for each channel but also with limitations such as the light amplification band limitation, the transmission band of the optical fiber limitation, bandwidth limitations of optical devices, and others. One approach to counteracting these problems and limitations has been to increase the number of wavelengths by narrowing a wavelength interval instead of increasing the wavelength band which is limited to the most effective width. In this approach, the precision of the semi-conductor laser light source for the each wavelength becomes an even greater issue as a factor to prevent an increase in the number of wavelengths, for the reasons discussed above.

Dense WDM known as “DWDM” optical networks commonly have optical transmitter modules that deploy eight or more optical channels, with some DWDM optical networks employing more channels. The optical transmitter module generally comprises a plurality of discrete optical devices, such as a discrete group or array of semi-conductor laser sources of different wavelengths, a plurality of discrete modulators, an optical combiner, such as a star coupler, a multi-mode interference (MMI) combiner, and other discrete components. All of these optical components are optically coupled to one another as an array of optical signal paths coupled to the input of an optical combiner using a multitude of single mode fibers (SMFs), each aligned and optically coupled between discrete optical devices. A semiconductor modulator/laser (SML) may be integrated on a single chip, which in the case of an electro-absorption modulator/laser (EML) is an EA (electro-absorption) modulator. The modulator, whether an EA or other, modulates the CW (continuous wave) output of the laser source with a digital data signal to provide a channel signal which is different in wavelength from each of the other channel signals of other EMLs in the transmitter module. Each optical channel is typically assigned a minimum channel spacing or bandwidth to avoid crosstalk with other optical channels. In some cases, channel spacing is greater than 50 GHz, with 50 GHz and 100 GHz being common channel spacing.

Conventional DWDM optical networks require a large number of discrete optical components in the optical transmitter and receiver. More particularly, each optical transmitter typically includes a semiconductor laser source for each optical channel. Narrowing the distance between wavelengths is limited when considering the factors such as wavelength accuracy of the discrete semiconductor laser light source, a production variance of wavelength filters, and other factors as described above in some detail. Therefore, the method of narrowing the distance between wavelengths can become prohibitively expensive and only marginally acceptable. Even though high density manufacturing techniques have been employed, such as integrated circuitry and etching, such approaches have met with limited success. Additionally, since the system still involves multiplexing, it is limited in the amount of data per unit of time that can be communicated.

Although multiplexing has the advantage of lessening the amount of hardware required for the communication of data, it has an adverse impact on speed or data density. The flow of data is reduced in a multiplexed system due to the serial nature of data flow resulting in a relatively slow system. Essentially, multiplexing reduces the rate at which data can be acquired from an individual channel because of the time-sharing strategy between channels. Multiplexing can introduce other problems. For instance, the multiplexer's high source impedance can combine with stray capacitance to increase settling time and generate cross talk between channels. Multiplexer impedance itself also can degrade signals. A solid-state multiplexer with an impedance of tens or hundreds of ohms can cause problems. Furthermore, the technical problems discussed above and associated with a large number of individual light sources stem from the approach of using multiple active light sources to provide multiple light for channels of data. This technology of using “active” individual devices for each channel, such as using a semiconductor laser device to provide each individual channel of light, results in the electrical accuracy and size problems discussed above.

Those of skill in the art have identified a need for the ability to provide ever-increasing amounts of data in shorter time periods without resorting to large increases in hardware with their attendant individual deficiencies and interaction deficiencies. Those of skill in the art have also recognized a need for a simpler system which is lower in cost and which is easier to manufacture, and that can provide for a higher density of data communication. Further, those of skill in the art have noted a need for a high density data communication system that offers the ability to communicate large quantities of data optically without the need for highly efficient or accurate individual light sources. The present invention fulfills these and other needs in the art.

### SUMMARY OF THE INVENTION

Briefly and in general terms, the invention is directed to a system and associated method for communicating high density or large volumes of data optically. Large amounts of data, either digital or analog, may be communicated in parallel at greater bit rates using a diffraction device for creating large numbers of light channels usable for communicating data.

In a general aspect in accordance with the invention, there is provided a high density optical data communications system that comprises a transmitter comprising: a multiple-wavelength light source that provides a source light containing a combined plurality of constituent lights having different wavelengths, a first diffracting device located to receive the source light and configured to spatially separate the source light into its constituent lights and to order those constituent lights in a predetermined pattern according to their wavelengths, a light modulating processing array located to receive the predetermined pattern of constituent lights in parallel, the light modulating processing array comprising a plurality of light modulator processor elements each of which is configured to modulate a received constituent light with data in parallel with other light modulator processor elements to form parallel light channels, and output the modulated constituent light channels in parallel, a light combiner configured to receive the output modulated constituent light channels in parallel and combine them into a composite data communication light, and a receiver comprising a second diffracting device located to receive the composite data communication light and spatially separate the received composite data communication light into its constituent modulated light channels and to order those constituent modulated light channels into the predetermined pattern according to their wavelengths, and a light demodulating processing array located to receive the predetermined pattern of modulated constituent light channels diffracted from the composite data communication light in parallel, the light demodulating processing array comprising a plurality of light demodulator processor elements configured to demodulate the received constituent modulated light channels in parallel to extract the data from each constituent modulated light.

In detailed aspects in accordance with the invention, the first diffracting device comprises a diffraction grating configured to receive the source light and spatially separate the source light into its constituent lights while automatically ordering those separated constituent lights in the predetermined pattern comprising an ascending order of wavelengths. The second diffracting device comprises a second diffraction grating configured to receive the composite data communication light and spatially separate the composite data communication light into its constituent modulated light channels while automatically ordering those separated constituent modulated light channels in the predetermined pattern comprising the ascending order of wavelengths. A diffraction grating is a passive diffraction device not requiring the use of power to operate. The light combiner is configured to receive the modulated lights from the light modulating processing array without further diffraction.

In a yet further aspect, light modulator processor elements are configured to modulate the constituent lights with data to form light channels. In a more detailed aspect, the light modulator processor elements impress a carrier signal on constituent lights with a data modulation of the carrier signal to form constituent light channels. The light modulator processor elements are further configured to impress data comprising the total number of light channels of the system, channel identification, and frequency of the carrier signal. The light modulator processor elements are configured to modulate constituent lights with a channel position marker indicating the relative position of the constituent light channel in relation to other channels in the predetermined pattern, whereby the position of the light channel and its data can be determined from data on the channel or from the position marker showing where in the predetermined pattern it is located.

In further aspects, the receiver forwards a loss-of-data signal to the transmitter when data cannot be demodulated from a constituent light channel. The transmitter changes the constituent light channel on which data is being impressed in response to the loss-of-data signal. The light modulating processing array is also configured to impress different carrier frequencies on different modulated light channels of the array.

In other more detailed aspects, the optical data communication system comprises a second transmitter that comprises a second multiple-wavelength light source that provides a second source light containing a combined plurality of constituent lights having different wavelengths, all of which are from a spectrum of light that is different from the spectrum of light from which another transmitter in the system provides its constituent lights; a third diffracting device located to receive the second source light and configured to spatially separate the second source light into its constituent lights and to order those constituent lights from the second source light in the predetermined pattern according to their wavelengths, and a second light modulating processing array located to receive the predetermined pattern of constituent lights from the second source light in parallel, the second light modulating processing array comprising a plurality of light modulator processor elements each of which is configured to modulate a received constituent light from the second source light with data in parallel with other light modulator processor elements to form parallel light channels, and output the modulated constituent light channels from the second source light in parallel, wherein the light combiner is configured to receive the output modulated constituent light channels of all transmitters in parallel and combine them together into the composite data communication light.

In additional detailed aspects, the receiver comprises a plurality of diffracting devices disposed in serial configuration to receive the composite data communication light and spatially separate the received composite data communication light into its constituent modulated light channels and to order those constituent modulated light channels into the predetermined pattern according to their wavelengths. The optical data communication system comprises a second receiver comprising a third diffracting device located to receive the composite data communication light and spatially separate the received composite data communication light into its constituent modulated light channels and to order those constituent modulated light channels into the predetermined pattern according to their wavelengths, and a second light demodulating processing array located to receive the predetermined pattern of modulated constituent light channels diffracted from the composite data communication light in parallel, the light demodulating processing array comprising a plurality of light demodulator processor elements configured to demodulate the received constituent modulated light channels in parallel to extract the data from each constituent modulated light, whereby multiple receivers may receive the same data.

Other aspects include the optical data communications system further comprising an electrically writable, electrically erasable, and non-volatile memory array connected to the demodulating processing array to receive the extracted data from the light demodulating processing array, the memory array comprising a plurality of memory elements, each memory element connected to a demodulator processor element and configured to receive data from the connected demodulator processor element in parallel with other memory elements of the array and to store that data. The memory array comprises flash memory. The optical data communications system further comprises a second transmitter comprising a second multiple-wavelength light source that provides a second source light containing a combined plurality of constituent lights having different wavelengths, a third diffracting device located to receive the second source light and configured to spatially separate the second source light into its constituent lights while automatically ordering those constituent lights in a predetermined pattern according to the wavelengths of the constituent lights, a second light modulating processing array located to receive the predetermined pattern of constituent lights in parallel, the second light modulating processing array coupled to the memory array, and comprising a plurality of light modulator processor elements each of which is configured to modulate a received constituent light with data received from a memory element of the memory array in parallel with other light modulator processor elements to form parallel light channels, and output the modulated constituent light channels in parallel, wherein the second transmitter permits the data of the memory array to be read from the memory array in parallel and impressed on light channels for further use.

In yet a further detailed aspect, the optical data communication system further comprises a beam splitter configured to split the source light into a first portion and a second portion with the first portion being provided to the first diffraction device and the second portion comprising the second light source and being provided to the third diffraction device.

Yet further detailed aspects include a high density optical data communications system that comprises a first and a second transmitter, each comprising a multiple-wavelength light source that provides a source light containing a combined plurality of constituent lights having different wavelengths, a first diffracting device located to receive the source light and configured to spatially separate the source light into its constituent lights and to order those constituent lights in a predetermined pattern according to their wavelengths, a light modulating processing array located to receive the predetermined pattern of constituent lights in parallel, the light modulating processing array comprising a plurality of light modulator processor elements each of which is configured to modulate a received constituent light with data in parallel with other light modulator processor elements to form parallel light channels, and output the modulated constituent light channels in parallel, a light combiner configured to receive the output modulated constituent light channels in parallel and combine them into a composite data communication light, a first and a second receiver, each comprising a second diffracting device located to receive the composite data communication light and spatially separate the received composite data communication light into its constituent modulated light channels and to order those constituent modulated light channels into the predetermined pattern according to their wavelengths and a light demodulating processing array located to receive the predetermined pattern of modulated constituent light channels diffracted from the composite data communication light in parallel, the light demodulating processing array comprising a plurality of light demodulator processor elements configured to demodulate the received constituent modulated light channels in parallel to extract the data from each constituent modulated light, wherein the first receiver is connected to the second transmitter and provides the extracted data from the first receiver to the light modulating processing array of the second transmitter wherein the light modulator processor elements of the second transmitter modulate a received constituent light with the extracted data from the first receiver, wherein the source light of the first transmitter consists of a different spectrum of light than that of the source light of the second transmitter, whereby the second transmitter and receiver shift the same data provided to the first transmitter to a different light spectrum by means of the second transmitter.

Aspects of a method in accordance with the invention include providing a method of optically communicating high density data that comprises diffracting a multiple-wavelength source light into a plurality of spatially separated constituent lights of different wavelengths in a predetermined pattern, modulating the constituent lights in accordance with data in parallel to form parallel light channels, combining in parallel the modulated constituent light channels to form a composite data communication light, diffracting the composite data communication light into the plurality of spatially separated modulated constituent light channels of different wavelengths in the predetermined pattern, and demodulating in parallel the modulated constituent light channels to extract the data from each constituent modulated light channel.

More detailed method aspects include that the step of combining comprises combining the modulated constituent light channels without further diffraction before the combining step. The method further comprises modulating constituent lights with data to form data light channels. A more detailed aspect comprises impressing a carrier signal on constituent lights and modulating the carrier signal with data to form constituent light channels. The method yet further comprising the step of impressing data comprising the total number of light channels of the system, channel identification, and frequency of the carrier signal. The method also comprising modulating constituent lights with data to form constituent light channels. The method further comprising the step of modulating constituent lights with a channel position marker indicating the relative position of the constituent light channel in relation to other channels in the predetermined pattern, whereby the position of the light channel and its data can be determined from data on the channel for from the position marker showing where in the predetermined pattern it is located. Another aspect involves the method further comprising the step of impressing different carrier frequencies on different modulated light channels of the array.

The features and advantages of the invention will be more readily understood from the following detailed description which should be read in conjunction with the accompanying drawings.

### BRIEF DESCRIPTION OF THE DRAWINGS

FIG. 1 presents a block diagram and information flow diagram of a high density optical data communication system in accordance with aspects of the present invention showing a transmitting section, a receiving section, and a light carrier device between the two;

FIG. 2 is a block diagram showing a light modulating processing array receiving parallel lines of data in the form of electrical signals for modulating light to form output data light channels, as well as control data from the associated array controller including various information about the number of channels, carrier frequencies on the channels, and other information provided by the array;

FIG. 3 is a more detailed block diagram of a high density optical data communications system in accordance with aspects of the invention showing various hardware components in block form for both the transmitting and receiving sections as well as the general flow of optical energy in communicating information;

FIG. 4 is a diagram showing the use of the high density optical data communications system in accordance with aspects of the invention to conduct data through a substrate with a transmitter on the upper side of the substrate, a receiver on the bottom side of the substrate, and a light carrier through the substrate as a feed through, which is in optical communication with both the transmitter and the receiver;

FIG. 5 is a diagram showing the use of a high density optical data communications system in accordance with aspects of the invention over a length of optical carrier line to shift the light wavelengths of the optical energy being used to carry data at a position along the optical carrier line to accommodate particular optical response characteristics of the optical carrier line for increased data flow and accuracy;

FIG. 6 provides a block diagram and data flow diagram showing the use of a high density optical data communication system in accordance with aspects of the invention for storing large quantities of data in parallel to an electrically writable, electrically erasable, and non-volatile memory coupled to the receiver;

FIG. 7 provides a block diagram of subject matter similar to FIG. 6 with the addition of a further transmitter used to read the data stored in the memory of FIG. 6 in parallel to provide a high volume and high speed transmission of the memory data in which the same light source is used for both the writing transmitter and the reading transmitter;

FIG. 8 provides a block diagram similar to the subject matter of FIG. 7 in which the read transmitter has a light that is separate from the light source of the write transmitter with the two lights sources encompassing different spectra so that the read light channels will be of different wavelengths than the write light channels;

FIG. 9 shows a high density optical data communications system in accordance with aspects of the invention in which the transmitter comprises multiple light sources, each having a different spectrum of light than every other light source, being used to provide even larger amounts of optical data channels;

FIG. 10 shows the use of a plurality of diffraction devices coupled serially to spread a large spectrum of one diffraction device into two smaller diffraction spectra; and

FIG. 11 shows a closed-loop, hand-shaking high density optical data communications system in accordance with aspects of the invention in which the receiver communicates various data-related information back to the transmitter which is programmed to take certain transmitting actions according to the receiver performance.

### DETAILED DESCRIPTION OF THE PREFERRED EMBODIMENTS

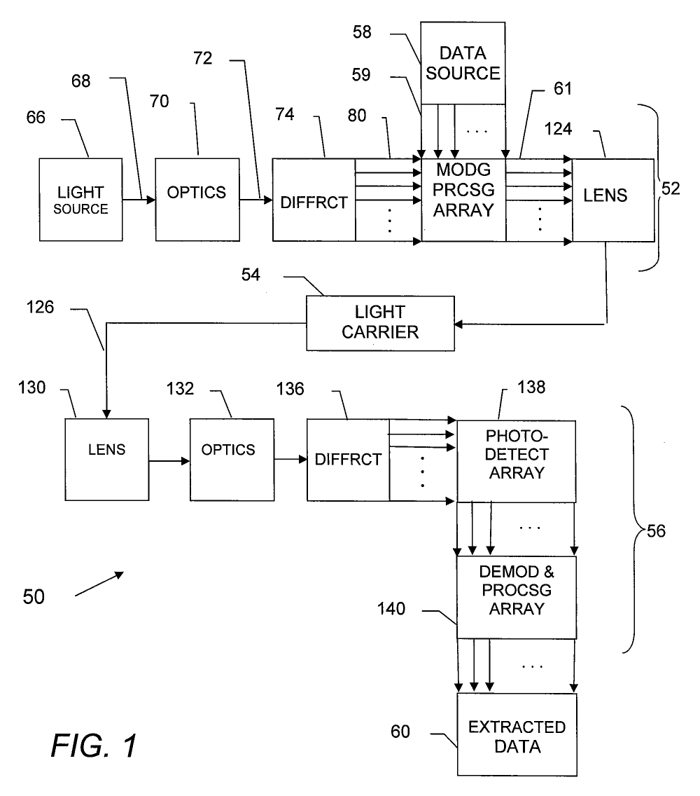

Referring now in more detail to the exemplary drawings for purposes of illustrating embodiments of the invention, wherein like reference numerals designate corresponding or like elements among the several views, there is shown in FIG. 1 an overall system block diagram and flow chart of a high density optical data communication system 50 in accordance with aspects of the invention. The embodiment shown includes a transmitter 52, a light carrier 54, and a receiver 56. In overview, a data source 58 provides data for communication to the receiver 56. The optical data communication system in accordance with the invention provides a system and method for communicating large amounts of that data in parallel optically.

As used herein, “data” is meant in its broad sense. That is the term “data” is meant to encompass signals, carrier waves or carrier signals, information, digital signals, analog signals, and other information in electrical or optical or other forms.

While in FIG. 1, a one-way transmission and reception system 50 is shown, this is for the purpose of clarity of illustration only. In another embodiment as shown and described below, changes may be made so that closed-loop, hand-shaking, or two-way communications are provided between the receiver and the transmitter using the system shown with some modifications. In such a case, devices would be provided so that transmission and reception may occur at the same site. In such a closed-loop system, the receiver may communicate reception problems to the transmitter which may then retransmit the data, or switch optical channels for transmitting the data or use different carrier frequencies, or take other steps in an attempt to remedy the transmission problems.

The light carrier 54 is a device capable of carrying optical energy for the distance required. It may take different forms, including but not limited to an optical fiber, and may include one or more optical fiber links forming an optical span with one or more intermediate optical nodes. It may include amplifiers, filters, and other optical devices that participate in carrying the optical energy for the required distance.

The light source 66 comprises a multi-wavelength light source that provides a source light having a combined plurality of constituent lights having different wavelengths. In one embodiment, the light source 66 provides a beam 68 of white light; however, other types of light sources and wavelengths of light may be used as long as they contain multiple wavelengths of light. For example, an infrared light source or an ultraviolet light source having a relatively broad bandwidth may be used. Use of a broadband light source 66 assists in the generation of a large number of light channels, as will be seen below. This in turn permits a high density of signal channels for communicating data optically.

Although indicated merely as an “optics” device 70 in FIG. 1 and as used elsewhere, such “optics” designation is a general category that is meant to include devices used to shape or control the light in a way needed for the next step of the use of that light. For example, the optics device 70 in FIG. 1 may comprise a diffuser to evenly spread the light beam 68 into a desired incident light beam 72, and direct that beam across a diffraction device 74. As another example, the optics device 70 may also comprise a polarizer to reduce the possibility of cross-talk and other noise-related phenomena. The light beam 72 is then provided to a diffraction device, which in this case is a diffraction grating 74 that is reflective.

In this embodiment, the diffraction grating 74 comprises a highly reflective planar diffraction grating with the periodicity of the grating lines selected in accordance with the desired number of light channels. Because the diffraction grating is used, the beam of the light 72 incident upon the diffraction device 74 is spatially separated into a spectrum of its constituent lights, or colors or wavelengths, to always form a light pattern 80 according to the wavelengths of the constituent lights with shorter wavelengths at one end of the pattern and longer wavelengths at the opposite end of the pattern. This embodiment has a pattern of constituent lights ordered by ascending order of wavelength. This rigid pattern is referred to as a predetermined pattern. That is, the output from such a diffraction device is a large number of constituent lights 80 which are always placed in order from the shorter wavelengths to the longer wavelengths (ascending order). Due to the fixed positions of the constituent lights in this predetermined pattern, their relative positions in relation to each other are always known.

Although referred to as a diffraction device and described in one embodiment as a grating, the diffraction device 74 may comprise other types of frequency- or wavelength-dependent dispersers. Effectively, the diffraction device spreads out a spectrum of wavelengths of the light incident on it into a predetermined pattern by wavelength with relative positions of the constituent lights being known. It may not only take the passive form shown and described, which is a passive grating, but may also take the form of active devices that provide diffraction to produce large numbers of constituent lights.

The constituent lights 80 are then provided in order to a light modulating processing array 82, which also has a fixed position in relation to the diffraction device 74. The light modulating processing array comprises a large number of light modulator processor elements that receive one or more of the constituent lights and modulate those constituent lights according to data from the data source 58. In FIG. 1, the data source 58 provides a plurality of data lines 59 in parallel to the light modulating processing array. Each data line 59 includes, in this case, an electrical data signal that will be used by an element of the light modulating processing array to modulate a constituent light 80. In one embodiment, a large quantity of data lines 59 is brought in parallel to the light modulating processing array for modulating a large quantity of constituent lights in parallel thereby forming a large density, or volume, or quantity of light channels. The modulating data 59 may include digital data, analog data, or other forms of data.

In one embodiment, a carrier frequency is applied to the intensity of the constituent lights 80 by the light modulator processor elements for the purpose of reducing noise detriment to the light channels. Furthermore, the data 59 may be impressed on the carrier by frequency modulation (“FM”) to further lessen any adverse impacts of noise and to obtain the well-known benefits that FM provides. In one particular embodiment, a carrier frequency of 1 GHz was used, which was frequency modulated by the digital data 59 to be communicated. In another embodiment, the carrier frequency may be modulated by analog data. Once the data has been impressed on a constituent light, that modulated constituent light then becomes referred to as a “light channel.”

Because of the large inherent bandwidth of optical systems, such systems are being increasingly utilized for transmitting information, generally over fiber optic cables, in telephone, cable television, data transmission and processing and other applications. Heretofore, such systems have typically used amplitude modulation (AM) because it is simple to implement. However, frequency modulation (FM) is more power efficient as compared with amplitude modulation and can provide an order of magnitude or more increase in signal-to-noise ratio. While this signal-to-noise ratio advantage has been taken advantage of for many years in radio, FM is not widely employed to any extent in optical communications. Thus, even though wireless transmission encodes signals via FM because FM offers substantial power savings over AM, optical transmission tends towards AM because component technology for FM receivers and sources is limited. In this discussed embodiment, the intensity of the constituent lights is modulated in accordance with a carrier wave, and the carrier wave is modulated in accordance with the data 59 to be impressed and communicated by the light channels. As referred to herein, this use of a modulated carrier wave on the constituent lights is meant to be encompassed by the phrase “modulate a received constituent light with data” and by similar phrases or terms.

Note that use of a carrier with modulation on the carrier comprises just on embodiment. Other modulation schemes for modulating the constituent lights may be used, including, but not limited to, amplitude modulation.

The light modulating processing array 82 may be implemented by crystal, such as quartz, polymer, piezo-electric materials, or other technologies. Use of devices such as spatial light modulators (“SLM”) provides the ability to modulate light intensity in accordance with a carrier having data impressed on it. Effectively it modulates the intensity of a light beam in accordance with a selected carrier frequency, and, as discussed above, frequency modulates the carrier with data. Using frequency modulation for the data has the benefit of reduced noise, interference, and distortion.

The light modulating processing array 82 comprises a large number of closely-spaced light modulator processor elements or devices, each controlled by an array controller, in one embodiment. The modulation devices may be formed of crystals or polymers, or other materials. Each modulation device is configured, in one embodiment, to impress a carrier wave onto the light, such as a 1 GHz carrier, and also to modulate the carrier with data it receives from the processor. The modulator devices may be transmissive or reflective, or may have other configurations.

The individual constituent modulated light beams 61 then provided to a lens 124 and/or other optical devices that recombines the individual constituent modulated light channels together into a composite data communication light to a point or other shape for efficient communication through, in this embodiment, an optical fiber 54 to a receiver 56. After the recombined composite data communication light 126 is communicated to the receiver, it is received by a lens 130 and/or other optical elements or devices 132, that focuses the composite data communication light and further processes it as needed, such as a diffuser and/or polarizer or other devices, and provides that composite data communication light 126 to a highly-reflective diffraction device 136, in this embodiment. The receiver diffraction device 136 is similar to the transmitter diffraction device 74 and must be configured to diffract the incident light into at least as many, or more, constituent lights as the diffraction device 74 of the transmitter did. The receiver diffraction device 136 in this embodiment comprises a diffraction grating which once again separates the constituent modulated light channels from each other and aligns or orders them by their wavelengths in the predetermined pattern for processing. These separated constituent modulated light channels are directed as individual channels to a photo-detector array 138. Because a diffraction device 136 is used in the receiver 56 which separates the incident light into the same or more constituent light channels and aligns or orders those constituent light channels into the same predetermined pattern as was established in the transmitter 52, the constituent modulated light channels have the same relative positions to one another as they had in the transmitter 52. Therefore, they are once again in a known, or predetermined, order in relation to each other and because the lens 130, optics 132, the diffraction device 136 and the photo-detector array 138 are all in fixed positions in relation to each other, the light channels will also be in fixed and known relative positions to each other as they were in the transmitter 52.

The photo-detector array 138 comprises a plurality of photo-detector elements, each of which receives a light channel and converts or transduces the received light energy to an electrical energy output. The electrical outputs of the photo-detector elements of the array 138 are then provided to a light demodulating processing array 140 that is configured to extract the carrier signal and its data modulation and to furnish the extracted data 60. Because one or more light channels indicate the carrier frequency, the data extraction is easily carried out with greater accuracy.

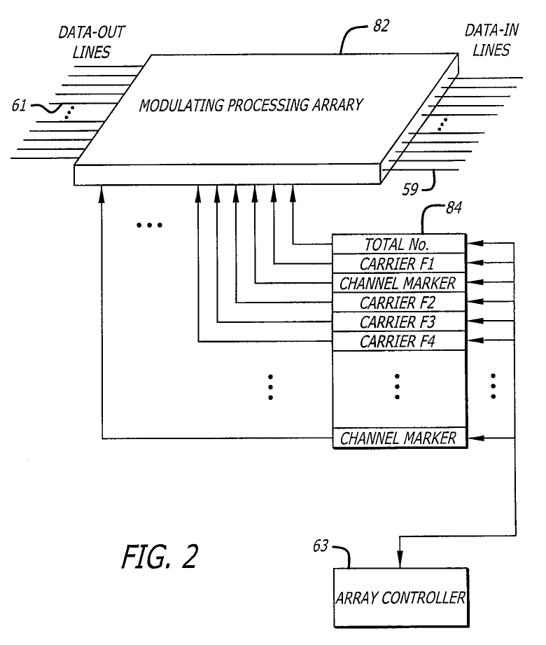

Referring now to FIG. 2, one exemplary scheme for assigning data to particular modulated light channels is shown. The data lines in 59 provide electrical data to be impressed on light channels and may be provided by various sources. The data lines out 61 provide the modulated light channels. The array controller 63 of the light modulating processing array 82 assigns data to particular light channels. The controller in this case selects certain channels to convey information about the overall system 50 relative to the lights channels. For example, data 84 may include the total number of light channels available, the various carrier frequencies used (F1, F2, F3, F4, etc.), which may vary by channel, channel markers, and other data. For example, the controller may use a particular light channel for a channel marker. An adjacent light channel may be used to indicate the total number of light channels used in the Data Channel No. 1. The next adjacent channel to the last may be used to indicate the carrier frequency for the light channels used in the Data Channel No. 1. The next three light channels may be used to carry individual data elements for the Data Channel No. 1. Various data and data encoding may be used in the modulation of the constituent light channels. Other information may be provided concerning data beyond what is discussed here.

As mentioned, other information or orders of information may be impressed on particular light channels and data may be mixed among different light channels. As an example only; three light channels may be assigned to parts of a first data channel while the next two adjacent light channels may be used for the next sequential data channel with the next few light channels after that returning to conducting data for the first data channel. Use of the data channel markers is useful to indicate to the receiver 56 for each light channel to which data channel it belongs. Furthermore, the markers of the light channels that are assigned to the data are known by the array controller 5 8 of the transmitter just as they are known to the array controller in the receiver 56. Therefore, because the light channels are aligned and ordered according to the predetermined pattern due to use of a diffraction device in both the transmitter and receiver, it is not required to be able to read all channels at the receiver to know which data pertains to which channel. Once one channel marker is successfully read, its position relative to all other channels is known due to use of this predetermined pattern and all channels that are readable can immediately be put in order even if some channels are missing at the receiver due to various adverse effects, such as noise. This allows for the immediate recovery of all readable data even under extremely adverse conditions where much of the data light channels may be otherwise unreadable.

Furthermore, in some cases, channel markers may be spaced apart with intervening light channels. For example, a channel marker may be used once very ten light channels, or once every one-hundred light channels, or otherwise. Additionally, where data comprises more than one bit, it may be spread in parallel among light channels. As an example, a sixteen-bit word may use sixteen light channels, one for each bit. Within light channels, multiplexing may be used as a way to communicate data.

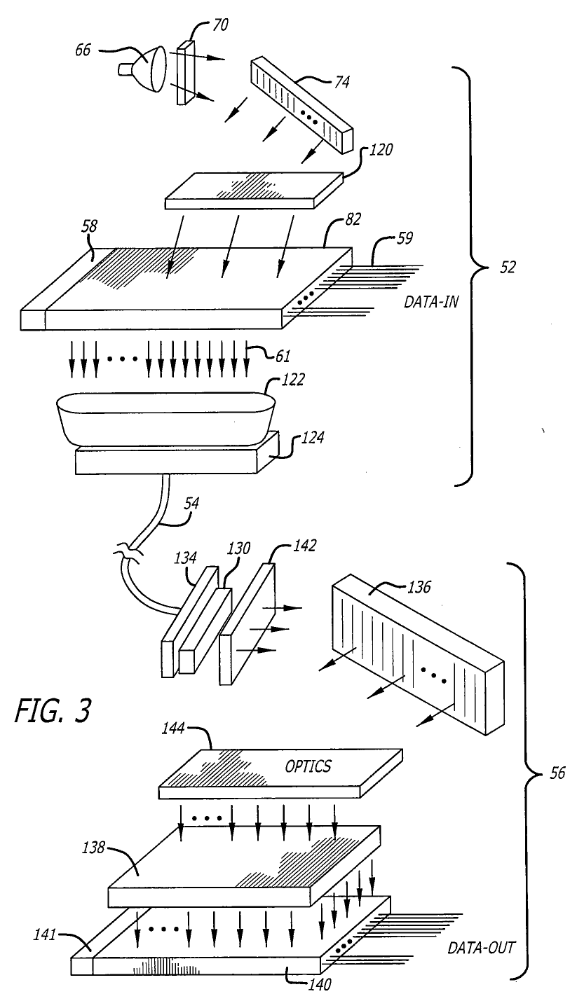

Turning now to FIG. 3, a more detailed block and flow diagram is provided that presents an embodiment of a high density optical data communication system and associated method in accordance with aspects of the invention. The multi-wavelength light source 66, in this case white light, is provided to a diffuser and a polarizer 70 and is then provided as an incident light beam to a highly-reflective, planar passive diffraction grating 74. The constituent lights of the incident white light are spread out by the diffraction grating in a periodicity that is in direct relation to the spacing of the grating lines. These constituent lights are in the predetermined alignment and order provided by the diffraction grating from shorter wavelengths at one end to longer wavelengths at the opposite end and are communicated through an optics processing device 120 as needed for light shaping or other purposes. The locations of the constituent lights on the light modulating processing array 82 are known because the light source 66, the planar diffraction grating 74, and the light modulating processing array 82 are in fixed positions in relation to each other. The modulator processor elements of the light modulating processing array then modulate the constituent lights in accordance with control exerted by the array controller 58 and the data in 59, as discussed above.

The diffraction device 74 provides the constituent lights in parallel, and the data-in 59 are received by the light modulating processing array 82 in parallel. The light modulating processing array processes all constituent lights with the data 59 in parallel and outputs the light channels 61 in parallel thus providing for a large density or volume of optical light channels. The output light channels 61 are provided in parallel to a light collector 122 that provides the individual modulated constituent light beams to a lens 124 in parallel. The collector and lens provide a composite data communication light in which all light channels are intermixed. Depending on the device used to communicate the recombined light, the lens would be selected to receive the recombined light from the data modulator array 82 and focus it to the shape required for the composite light communication device 54. For example, in the embodiment where the communication device is an optical fiber 54, the lens may focus a light of light received from the data modulator array to a point to be input to the optical fiber 54.

After the recombined light in the form of the composite data communication light has been communicated to a receiver 56 by the light carrier 54, the composite data communication light is subjected to a diffuser 134 and then to a receiving lens 130. In this case, the receiving lens is selected to receive a point source of light from the diffused optical fiber 54 light, and focus that light to a line on a highly-reflective planar diffraction grating 136. A further polarizer 142 may be used to reduce cross-talk and interference. Other optical processing devices may also be interposed between the optical communication fiber 54 and the lens 130 and/or between the lens and the receiving diffraction grating 136, as desire for light shaping and for other reasons.

The diffraction grating 136, also referred to as a spectral separator or spectral splitter, should be equivalent to the diffraction device 74 used in the transmitter in that the diffraction device 136 at the receiver must provide at least as many constituent lights as did the transmitter diffraction device 74. Because diffraction is used in both, the same predetermined pattern of constituent lights will be provided by the receiver as at the transmitter, as is discussed above. As is discussed below, the light demodulating processing array 140 will extract the data from each constituent light channel for further use.

Use of diffusers and polarizers as described above and below have the beneficial result of making the light more uniform across devices use in the light processing and in the case of a polarizer, reduction of cross-talk and other spurious interference that may reduce the resolution of the optical system. Creation and use of such devices are well known to those of ordinary skill in the art and no further details are provided here.

The receiver 56 diffraction grating 136 spreads the composite light into its constituent lights, each having the data as impressed by the transmitter 52. The constituent lights are then provided to a photo-detector array 138 for transduction of the light energy into electrical energy. The photo-detector array comprises at least as many photo-detectors as the number of light channels. Another polarizer 144 may be used between the planar diffraction grating 136 and the photo-detector array 138 for the purpose of reducing possible cross-talk and other spurious signals that may degrade data resolution. Because the planar, linear diffraction grating was used, the constituent light colors are automatically placed in the predetermined pattern by wavelength, as they were in the transmitter. The position of each wavelength in relation to other wavelengths is therefore known to the photo-detector array 138 and the electrical signals provided by the photo-detector array will be known to relate to each other in the same way that the constituent light channels relate to each other.

It is preferable to use photo-diodes at the receiver 56 rather than charge coupled devices (“CCDs”). The shift register operation of CCDs results in sequential or serial operation, which is much slower than the parallel operation provided by photo-detectors. Although photo-diodes are mentioned, other technologies providing the conversion or transduction of optical signals to electrical signals in a parallel manner may be usable.

The electrical signals from the photo-detectors are then provided in parallel to a light demodulating processing array 140 for detection in the photo-detector outputs of the carrier signals and any data impressed on the carriers. Data markers in the form of data channel identifications or data channel numbers will provide the light demodulating processing array 140 and control electronics 141 with a reference point from which all other data channels can be determined. The position of each demodulation element in the light demodulating processing array 140 is known in the receiver 56 at the control electronics 141 as is the relation of each light channel to all other light channels due to the automatic ordering of constituent colors by the diffraction device 136. Therefore, once a data marker indicating a channel is found in the received data, all other channels will be known, as discussed above in more detail.

By knowing the relative positions of each modulation processor element in the array 82, they may be combined for transmission of channels of data. For example, a first modulation device (see FIG. 2) may be controlled by the processor to modulate its wavelength of light for the identification marker of a channel. A second, adjacent, higher wavelength modulation processor element may be controlled to modulate its wavelength of light with the body of data that is related to the marker. A third, and also adjacent, but lower wavelength modulation processor element may be controlled by the processor to modulate its wavelength of light with a checksum or other data related to the ID and body data portions conducted by the first and second modulation processor elements. Various numbers of modulation processor elements and locations may be used. For example, the modulation processor elements conducting related data do not need to be immediately adjacent; they may be interspaced at known positions between combinations of modulation processor elements that are controlled to handle different data. The combination of certain modulation devices may form a single data channel, although they may modulate multiple light channels.

In accordance with an aspect of the embodiment shown, it is not necessary to match wavelengths at the receiving section with those at the transmitting section. The data on the data channels will enable matching. Each light channel gets a different ID number or marker. The controller electronics 141 will look for the markers and then sort the data. The diffraction grating splits the composite light into its various constituent wavelengths in a known order which enables location of data. The relative position of the channels is important to finding data. One light channel may inform the controller electronics 141 about how many total channels there are, the carrier frequency, and other data. If the receiver is unable to find data with this amount of information, a hardware problem may be suspected and the receiver will inform the transmitter 52 that data was missed. The transmitter may then re-send the same data. In doing so, the transmitter may change the wavelengths for the communications, use a different carrier frequency, or make other changes.

Also, there are many different ways of forming channels of modulated light that may be used. Redundant channels may exist that can be compared against each other for error detection and possible correction. The reconstructed data is then displayed, broadcast, communicated in other ways, or used in other ways as appropriate.

Although shown as individual elements in the drawings and described as such above, some of the elements may be formed together. For example, a layered planar diffraction grating 74 could be grown in position with a data modulator processor array 82. The collector 122 and lens 124 may be an integral part of a circuit. The diffraction grating could be transmissive instead of reflective so that it could be formed directly over the data modulator array.

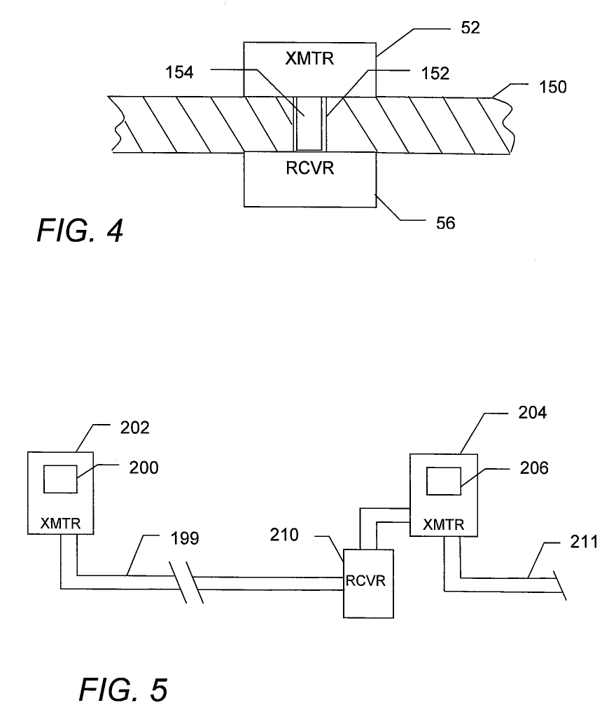

Turning now to another use of a high density optical data communication system and associated method, FIG. 4 shows the use of the transmitting section 52 and receiving section 56 to communicate data through a circuit board 150. A hole 152 is established through the board and in this case, a short optical fiber 154 is placed in the hole to conduct the recombined light from the transmitting section 52 to the receiving section 56. A feed-through hole may also be used in which the wall of the hole 152 is formed with a light reflective surface, such as a mirror, so that the recombined light from the transmitting section reaches the receiving section. Other light communication devices may be found usable. Both the transmitter and the receiver are mounted directly to the substrate so that extraneous light does not enter the hole 152. Various means of mounting the sections to the circuit board 150 may be devised. In a preferred case where there is no intervening substrate, one chip having one part of the optical communication system could be grown on another.

FIG. 5 is a diagram showing the use of the high density optical communication system to shift light wavelengths along a light carrier 199. In this case, the light source 200 in the first transmitter 202 has a particular spectrum. The light source 206 in the second transmitter 204 has a different spectrum. The data transmitted by the first light source transmitter is received downstream by the receiver 210 and that extracted data is directly provided to the second transmitter 204. Because the second transmitter has a different light spectrum for the light source, the data is effectively impressed on light have a spectrum that is better suited to the second length 211 of the light carrier. This process of demodulating and re-modulating is referred to as “piping.”

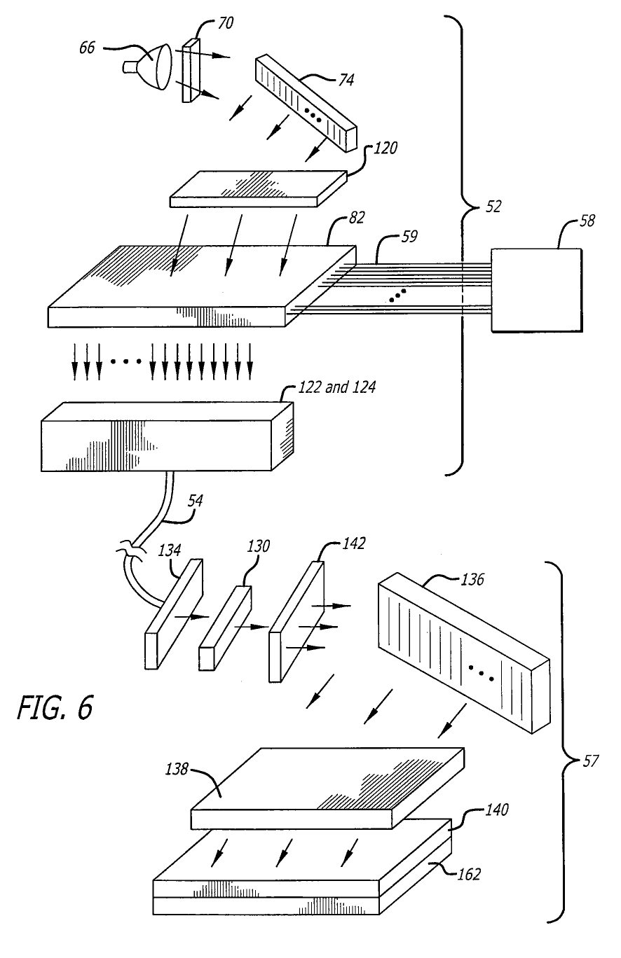

Turning now to FIG. 6, there is shown is a more detailed block diagram and flow diagram showing the use of a high density optical data communication system in accordance with aspects of the invention for storing large amounts of data in parallel. As in FIG. 3, a multi-wavelength light source 66 provides a spectrum of light through optic processing devices as necessary to a diffraction device 74 that separates the light into its constituent colors. The data modulation array 82 impresses large amounts of data on the numerous light channels created by the diffraction grating. Because all light channels are created at once, impressing data on all light channels can occur in parallel. The encoded light channels are recombined 122, focused 124 on the communication device 54 and communicated to a receiving section 57. The recombined light is once again spread out into its constituent colors, but in this case with data on the light channels, through use of the receiving diffraction grating 136. The photo-diode array 144 functions as before and the data demodulating processing array 140 extracts the actual data from the photo-diode array electrical signals.

In the case of FIG. 6, each element of the demodulator array is directly coupled to an associated memory element in a large volume, non-volatile memory device 162. High write speed of the memory device is desirable and the ability to be read by the computer 58 at a later time is also desirable. A memory controller 164 would be used to control the writing and reading functions of the memory device 162.

One suitable memory 162 available on the market today is a flash type memory device having large numbers of memory elements with very high write speeds. However, other types of EEPROM-type memory devices may be usable provided that they are electrically writable, electrically erasable at the bit level, and are non-volatile. As referred to herein, “flash” memory is a non-volatile memory device that retains its data when the power is removed. As is known, flash memory is formed in an array of memory cells made from floating-gate transistors. In traditional single-level cell (SLC) devices, each cell stores only one bit of information while multi-level cell (MLC) devices, can store more than one bit per cell by choosing between multiple levels of electrical charge to apply to the floating gates of its cells. In NOR gate flash, each cell resembles a standard MOSFET, except the transistor has two gates instead of one. On top is the control gate (CG), as in other MOS transistors, but below this there is a floating gate (FG) insulated all around by an oxide layer. Also available are NAND flash memory devices in which the NAND gate flash uses tunnel injection for writing and tunnel release for erasing. NAND flash memory forms the core of the removable USB storage devices known as USB flash drives, most memory card formats available today and many DS storage devices such as N-Card (wireless network card). Such flash memories may be usable as well as other electrically writable, electrically erasable, and non-volatile memory devices.

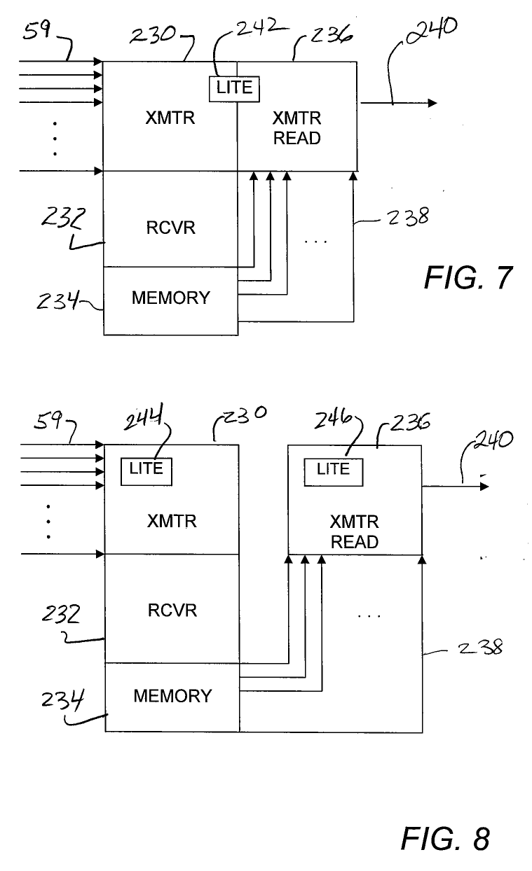

FIG. 7 provides further embodiment of a large density, high volume, and fast speed memory system in accordance with aspects of the invention. As described previously, data is stored into memory in parallel and can be extracted from memory in parallel to result in extremely fast data communication speeds. Data-in lines 59 bring data into a first transmitter 230 in accordance with the transmitter described and shown previously. The lights channels from the first transmitter 230 are provided to a receiver either directly by connecting light channels from the transmitter directly into photo-detector elements of the receiver, or through a composite data carrier 54 (not shown) as described previously. The data outputs of the receiver are then stored in the memory 234 in parallel by directly linking the demodulator processor elements to memory cells or elements. As described above, flash memory may be used.

To read the stored data, a second transmitter 236 is connected to the memory device 234 by parallel lines 238. In one embodiment, each memory element has a data line 238 directly connected to the modulating processing array of the second transmitter 236 so that all of the contents of the memory may be read directly and in parallel by the second transmitter. 236. The output 240 of the second transmitter may then be used further. In the embodiment shown in FIG. 7, both the first 230 and second 236 transmitter use the same light source 242. A beam splitter or other means may be used to provide the light from the same light source to both transmitters.

Referring now to FIG. 8, the same arrangement as FIG. 7 is provided except that the first transmitter has a light source 244 separate from the second transmitter light source 246. This would enable the data coming in 59 to be read in one light spectrum while the data output 240 by the second transmitter may be in a different light spectrum.

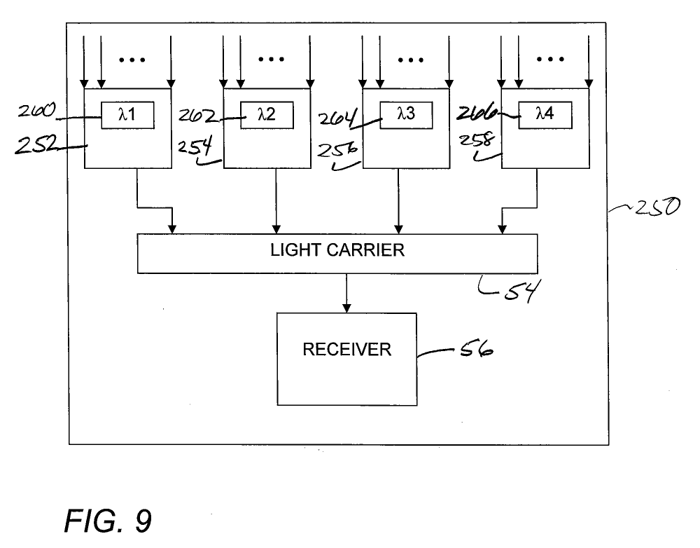

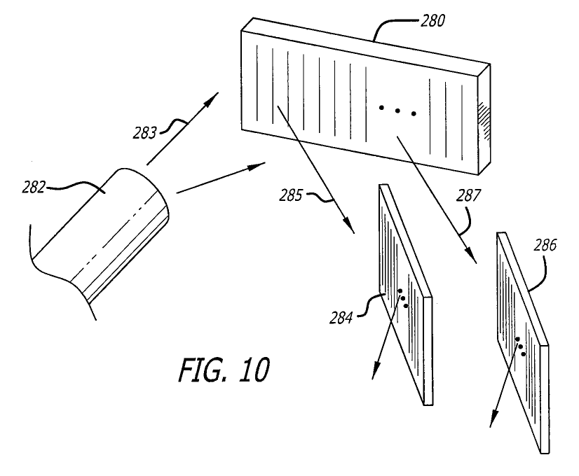

Turning now to FIG. 9, a high density wave channel optical data communication system 250 in accordance with other aspects of the invention is presented. In this case, four transmitters 252, 254, 256, and 258 are provided, each with a separate light source 260, 262, 264, 266, each of which has a different light spectrum indicated by the symbol λ1, λ2, λ3, λ4 for convenience, than all other light sources with different constituent lights. FIG. 9 provides a bank of light sources, each of which has a different light spectrum to provide many more channels that the one light source arrangement shown in FIG. 1. Different data lines and data are provided to each transmitter. Through the arrangement of FIG. 9, a much larger spectrum of light is available to the system which therefore results in lower bandwidth requirements for each transmitter. Each of the transmitters of FIG. 9 is as shown and described above in relation to the other figures, in particular FIG. 1, and each provides a plurality of light channels. The light carrier 54 and the receiver 56 are as described previously. A separate diffraction device is used for each transmitter to provide, effectively, the arrangement of a plurality of transmitters to one receiver.

Because the light receiver of FIG. 9 will now be receiving a much larger number of light channels at a possibly much larger spectrum of light than the system 50 of FIG. 1, a larger, diffraction device may be needed (not shown). One possible configuration for diffraction in the system of FIG. 9 is presented in FIG. 10. In this figure, the light carrier 282 is an optical fiber with appropriate optics at its terminal end to form a composite data bean 283 to encompass the diffractor 280. However, instead of a single diffracting device 280, sub-diffracting devices 284 and 286 are provided to receive different reflected, diffracted portions 285 and 287 of the spectrum from the first, much larger diffractor 280. The sub-beams from each of the sub-diffraction devices would then be directed to appropriate portions of a modulating processing array for processing as described above in detail.

In other arrangements, a plurality of receivers may be connected to a single transmitter (not shown) so that the data provided by a transmitter can be received in multiple places for different uses, as needed.

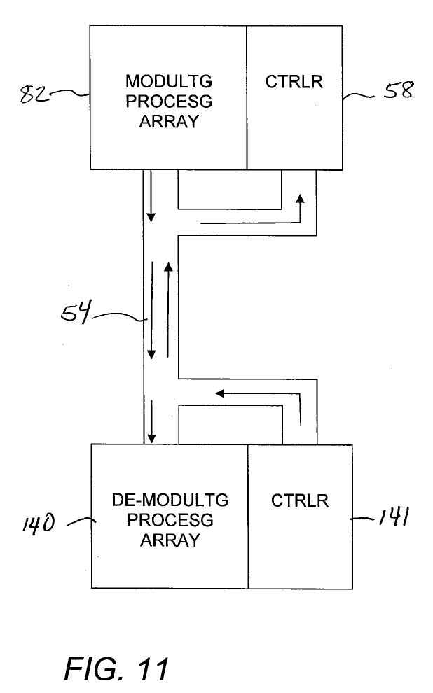

The system shown in FIG. 11 comprises a closed-loop, hand shaking, or feedback system in which the receiver provides control information to the transmitter. In FIG. 11, the controller 141 of the demodulating processing array 140 provides information through the optical carrier 54 to the controller 58 of the modulating processing array 82. Such information may take the form of “loss of data” on certain channels, or other information. In response, the controller 58 of the modulating processing array may change carrier frequencies, block light channels from further operation and switch their data to other light channels, or other actions.

It is to be understood that references to the light modulator processor elements being configured “to modulate the received constituent lights with data” is meant to be broad in scope and meaning. That is, the above-quoted phrase is meant to encompass modulation of any type, including, but not limited to, amplitude modulation, phase modulation, and frequency modulation, whether performed directly or indirectly, and is meant to include the use of impressing a carrier signal or wave on the constituent lights and using the data to modulate the carrier signal.

The embodiments described therefore are to be considered in all respects as illustrative and not restrictive. Although the present invention has been described in terms of certain preferred embodiments, other embodiments that are apparent to those of ordinary skill in the art are also within the scope of the invention. Accordingly, the scope of the invention is intended to be defined only by reference to the appended claims.

What is claimed is:

1. A high density optical data communications system, comprising:
a transmitter comprising:
a multiple-wavelength light source that provides a source light containing a combined plurality of constituent lights having different wavelengths;
a first diffracting device located to receive the source light and configured to spatially separate the source light into its constituent lights and to order those constituent lights in a predetermined pattern according to their wavelengths;
a light modulating processing array located to receive the predetermined pattern of constituent lights in parallel, the light modulating processing array comprising a plurality of light modulator processor elements each of which is configured to modulate a received constituent light with data in parallel with other light modulator processor elements to form parallel light channels, and output the modulated constituent light channels in parallel;
a light combiner configured to receive the output modulated constituent light channels in parallel and combine them into a composite data communication light;
a receiver comprising:
a second diffracting device located to receive the composite data communication light and spatially separate the received composite data communication light into its constituent modulated light channels and to order those constituent modulated light channels into the predetermined pattern according to their wavelengths; and
a light demodulating processing array located to receive the predetermined pattern of modulated constituent light channels diffracted from the composite data communication light in parallel, the light demodulating processing array comprising a plurality of light demodulator processor elements configured to demodulate the received constituent modulated light channels in parallel to extract the data from each constituent modulated light.

2. The optical data communications system of claim 1 wherein the first diffracting device comprises a diffraction grating configured to receive the source light and spatially separate the source light into its constituent lights while automatically ordering those separated constituent lights in the predetermined pattern comprising an ascending order of wavelengths.

3. The optical data communications system of claim 2 wherein the second diffracting device comprises a second diffraction grating configured to receive the composite data communication light and spatially separate the composite data communication light into its constituent modulated light channels while automatically ordering those separated constituent modulated light channels in the predetermined pattern comprising the ascending order of wavelengths.

4. The optical data communications system of claim 1 wherein the light combiner is configured to receive the modulated lights from the light modulating processing array without further diffraction.

5. The optical data communications system of claim 1 wherein light modulator processor elements are configured to impress a carrier signal on constituent lights with a data modulation of the carrier signal to form constituent light channels.

6. The optical data communications system of claim 5 wherein the light modulator processor elements are further configured to impress data comprising the total number of light channels of the system, channel identification, and frequency of the carrier signal.

7. The optical data communications system of claim 1 wherein light modulator processor elements are configured to modulate constituent lights with data to form constituent light channels.

8. The optical data communications system of claim 7 wherein light modulator processor elements are configured to modulate constituent lights with a channel position marker indicating the relative position of the constituent light channel in relation to other channels in the predetermined pattern, whereby the position of the light channel and its data can be determined from data on the channel for from the position marker showing where in the predetermined pattern it is located.

9. The optical data communications system of claim 1 wherein the receiver forwards a loss-of-data signal to the transmitter when data cannot be demodulated from a constituent light channel.

10. The optical data communications system of claim 9 wherein the transmitter changes the constituent light channel on which data is being impressed in response to the loss-of-data signal.

11. The optical data communications system of claim 1 wherein the light modulating processing array is configured to impress different carrier frequencies on different modulated light channels of the array.

12. The optical data communication system of claim 1 comprising a second transmitter comprising:
a second multiple-wavelength light source that provides a second source light containing a combined plurality of constituent lights having different wavelengths, all of which are from a spectrum of light that is different from the spectrum of light from which another transmitter in the system provides its constituent lights;
a third diffracting device located to receive the second source light and configured to spatially separate the second source light into its constituent lights and to order those constituent lights from the second source light in the predetermined pattern according to their wavelengths; and
a second light modulating processing array located to receive the predetermined pattern of constituent lights from the second source light in parallel, the second light modulating processing array comprising a plurality of light modulator processor elements each of which is configured to modulate a received constituent light from the second source light with data in parallel with other light modulator processor elements to form parallel light channels, and output the modulated constituent light channels from the second source light in parallel;
wherein the light combiner is configured to receive the output modulated constituent light channels of all transmitters in parallel and combine them together into the composite data communication light.

13. The optical data communication system of claim 12 wherein the receiver comprises a plurality of diffracting devices disposed in serial configuration to receive the composite data communication light and spatially separate the received composite data communication light into its constituent modulated light channels and to order those constituent modulated light channels into the predetermined pattern according to their wavelengths.

14. The optical data communication system of claim 1 comprising a second receiver comprising:
a third diffracting device located to receive the composite data communication light and spatially separate the received composite data communication light into its constituent modulated light channels and to order those constituent modulated light channels into the predetermined pattern according to their wavelengths; and
a second light demodulating processing array located to receive the predetermined pattern of modulated constituent light channels diffracted from the composite data communication light in parallel, the light demodulating processing array comprising a plurality of light demodulator processor elements configured to demodulate the received constituent modulated light channels in parallel to extract the data from each constituent modulated light;
whereby multiple receivers may receive the same data.

15. The optical data communications system of claim 1 further comprising an electrically writable, electrically erasable, and non-volatile memory array connected to the demodulating processing array to receive the extracted data from the light demodulating processing array, the memory array comprising a plurality of memory elements, each memory element connected to a demodulator processor element and configured to receive data from the connected demodulator processor element in parallel with other memory elements of the array and to store that data.

16. The optical data communications system of claim 15 wherein the memory array comprises flash memory.

17. The optical data communications system of claim 15 further comprising a second transmitter comprising:
a second multiple-wavelength light source that provides a second source light containing a combined plurality of constituent lights having different wavelengths;
a third diffracting device located to receive the second source light and configured to spatially separate the second source light into its constituent lights while automatically ordering those constituent lights in a predetermined pattern according to the wavelengths of the constituent lights;
a second light modulating processing array located to receive the predetermined pattern of constituent lights in parallel, the second light modulating processing array coupled to the memory array, and comprising a plurality of light modulator processor elements each of which is configured to modulate a received constituent light with data received from a memory element of the memory array in parallel with other light modulator processor elements to form parallel light channels, and output the modulated constituent light channels in parallel;
wherein the second transmitter permits the data of the memory array to be read from the memory array in parallel and impressed on light channels for further use.

18. The optical data communication system of claim 17 further comprising a beam splitter configured to split the source light into a first portion and a second portion with the first portion being provided to the first diffraction device and the second portion comprising the second light source and being provided to the third diffraction device.

19. A high density optical data communications system, comprising:
a multiple-wavelength light source that provides a source light containing a combined plurality of constituent lights having different wavelengths;
a first diffracting device located to receive the source light and configured to spatially separate the source light into its constituent lights while automatically ordering those constituent lights in a predetermined pattern according to the wavelengths of the constituent lights;
a light modulating processing array located to receive the predetermined pattern of constituent lights in parallel, the light modulating processing array comprising a plurality of light modulator processor elements configured to modulate the received constituent lights with data in parallel to form constituent light channels and output the modulated constituent light channels in parallel;
a light demodulating processing array located to receive the predetermined pattern of modulated constituent lights in parallel, the light demodulator processing array comprising a plurality of light demodulator processor elements each configured to receive a light channel and demodulate the received constituent modulated light channel in parallel with other light demodulator processor elements to extract the data from each constituent modulated light in parallel, and
an electrically writable, electrically erasable, and non-volatile memory array connected to the demodulating processing array to receive the extracted data from the light demodulating processing array, the memory array comprising a plurality of memory elements, each memory element connected to a demodulator processor element and configured to receive data from the connected demodulator processor element in parallel with other memory elements of the array and to store that data.

20. The high density optical data communications system of claim 19 wherein the memory array comprises flash memory.

21. The optical data communications system of claim 19 further comprising a second transmitter comprising:
a second multiple-wavelength light source that provides a second source light containing a combined plurality of constituent lights having different wavelengths;
a third diffracting device located to receive the second source light and configured to spatially separate the second source light into its constituent lights while automatically ordering those constituent lights in a predetermined pattern according to the wavelengths of the constituent lights;
a second light modulating processing array located to receive the predetermined pattern of constituent lights in parallel, the second light modulating processing array coupled to the memory array, and comprising a plurality of light modulator processor elements each of which is configured to modulate a received constituent light with data received from a memory element of the memory array in parallel with other light modulator processor elements to form parallel light channels, and output the modulated constituent light channels in parallel;
wherein the second transmitter permits the data of the memory array to be read from the memory array in parallel and impressed on light channels for further use.

22. The optical data communication system of claim 21 further comprising a beam splitter configured to split the source light into a first portion and a second portion with the first portion being provided to the first diffraction device and the second portion comprising the second light source and being provided to the third diffraction device.

23. A high density optical data communications system, comprising:
a first and a second transmitter, each comprising:
a multiple-wavelength light source that provides a source light containing a combined plurality of constituent lights having different wavelengths;
a first diffracting device located to receive the source light and configured to spatially separate the source light into its constituent lights and to order those constituent lights in a predetermined pattern according to their wavelengths;
a light modulating processing array located to receive the predetermined pattern of constituent lights in parallel, the light modulating processing array comprising a plurality of light modulator processor elements each of which is configured to modulate a received constituent light with data in parallel with other light modulator processor elements to form parallel light channels, and output the modulated constituent light channels in parallel;
a light combiner configured to receive the output modulated constituent light channels in parallel and combine them into a composite data communication light;
a first and a second receiver, each comprising:
a second diffracting device located to receive the composite data communication light and spatially separate the received composite data communication light into its constituent modulated light channels and to order those constituent modulated light channels into the predetermined pattern according to their wavelengths; and
a light demodulating processing array located to receive the predetermined pattern of modulated constituent light channels diffracted from the composite data communication light in parallel, the light demodulating processing array comprising a plurality of light demodulator processor elements configured to demodulate the received constituent modulated light channels in parallel to extract the data from each constituent modulated light;
wherein the first receiver is connected to the second transmitter and provides the extracted data from the first receiver to the light modulating processing array of the second transmitter wherein the light modulator processor elements of the second transmitter modulate a received constituent light with the extracted data from the first receiver;
wherein the source light of the first transmitter consists of a different spectrum of light than that of the source light of the second transmitter;
whereby the second transmitter and receiver shift the same data provided to the first transmitter to a different light spectrum by means of the second transmitter.

24. A method of optically communicating high density data, comprising:
diffracting a multiple-wavelength source light into a plurality of spatially separated constituent lights of different wavelengths in a predetermined pattern;
modulating the constituent lights in accordance with data in parallel to form parallel light channels;
combining in parallel the modulated constituent light channels to form a composite data communication light;
diffracting the composite data communication light into the plurality of spatially separated modulated constituent light channels of different wavelengths in the predetermined pattern; and
demodulating in parallel the modulated constituent light channels to extract the data from each constituent modulated light channel.

25. The method of optically communicating high density data of claim 24 wherein the step of combining comprises combining the modulated constituent light channels without further diffraction before the combining step.

26. The method of optically communicating high density data of claim 24 further comprising impressing a carrier signal on constituent lights and modulating the carrier signal with data to form constituent light channels.

27. The method of optically communicating high density data of claim 26 further comprising the step of impressing data comprising the total number of light channels of the system, channel identification, and frequency of the carrier signal.

28. The method of optically communicating high density data of claim 24 further comprising modulating constituent lights with data to form constituent light channels.

29. The method of optically communicating high density data of claim 24 further comprising the step of modulating constituent lights with a channel position marker indicating the relative position of the constituent light channel in relation to other channels in the predetermined pattern, whereby the position of the light channel and its data can be determined from data on the channel for from the position marker showing where in the predetermined pattern it is located.

30. The method of optically communicating high density data of claim 24 further comprising the step of impressing different carrier frequencies on different modulated light channels of the array.
